(19) United States
(12) Patent Application Publication
(10) Pub. No.: US 2026/0296859 A1
(43) Pub. Date: Oct. 1, 2026

(54) UPRIGHT OF A LIFT TRUCK

(71) Applicant: L.T.E. Lift Truck Equipment S.P.A., Ostellato(Ferrara) (IT)

(72) Inventors: Giovanni Paolo BONELLI, Ostellato (Ferrara) (IT); Marco GUZZINATI, Ostellato (Ferrara) (IT); Davide MASSARENTI, Ostellato (Ferrara) (IT)

(21) Appl. No.: 19/490,101

(22) PCT Filed: Jun. 5, 2024
(86) PCT No.: PCT/IB2024/055501

§ 371 Date: Dec. 4, 2025

(30) Foreign Application Priority Data
Jun. 7, 2023 (IT) 102023000011655

(51) Int. Cl. B66F 9/08

(52) U.S. Cl. CPC B66F 9/082

(57) ABSTRACT

A lift truck upright has a vertical direction of extension and includes a fixed section and a movable section, the fixed section including first and second parallel profiles extending along the vertical direction; the profiles each have a rear wall and an outer side wall, facing outward. The fixed section includes an element connecting the profiles close to a free upper end of the upright. The element is C-shaped with a main body, positioned facing the rear walls, and first and second parallel arms extending transversely from the main body. The arms are connected to the profiles, respectively, in respective coupling zones. The arms are positioned relative to the profiles such that the directions of extension of the arms define an acute angle “θ” with the vertical direction of extension The main body is positioned at a height higher than the coupling zones.

### TECHNICAL FIELD

This invention relates to an upright of a lift truck.

### BACKGROUND ART

Generally speaking, these uprights have a fixed structure comprising two vertical profiles and connecting elements aimed at fixing the profiles to each other to make the structure more stable.

The prior art connecting elements cross the fixed structure or are elements which have a C-shaped profile.

In particular, as illustrated in FIG. 1, the prior art connecting elements with a C-shaped profile extend, facing the driver's cab, in the upper portion of the upright, substantially parallel to the horizontal.

In use, both during driving of the truck and during movement of the loads to be lifted, this connecting element, in particular if located in the upper zone of the upright, may result in a reduction of the field of vision of the operator driving the lift truck.

Moreover, during tilting, the prior art connecting elements limit the angular travel of the upright towards the driver's cab of the truck.

In fact, the tilting angle is limited by the contact between the connecting element and the driver's cab.

With the aim of improving the field of vision of the operator driving the lift truck, the solution illustrated in patent document JP2001253697 is known wherein the connecting element is positioned inclined relative to the vertical profiles of the upright and directed downwards along the line of view of the operator.

However, this solution results in an interference between the connecting element and the driver's cab of the lift truck during tilting of the upright towards the cab, thus adversely affecting the performance of the truck.

### AIM OF THE INVENTION

In the technical sector of uprights for lift trucks the need is therefore felt of making innovative solutions which improve the field of vision of the driver without adversely affecting the performance levels of the upright.

In this context, the Applicant has developed an upright the features of which are set out in independent claim 1.

### BRIEF DESCRIPTION OF THE DRAWINGS

Further features and advantages of the invention are more apparent from the non-limiting description which follows of a preferred embodiment of an upright of a lift truck as illustrated in the accompanying drawings, in which:

FIG. 1 is a schematic side view of a prior art embodiment of an upright of a lift truck;

FIGS. 2 and 3 are schematic side views of an upright of a lift truck according to the invention;

FIGS. 4 and 5 are, respectively, a front view and a side view of the upright according to the invention;

FIGS. 6 and 7 schematically illustrate a detail of the upright according to the invention;

FIGS. 8 and 9 are, respectively, a front view and a side view schematically illustrating a variant embodiment of the upright according to the invention;

FIGS. 10 and 11 are schematic cross-sections of the variant embodiment of the upright of FIGS. 8 and 9 in a packed configuration and in a withdrawn configuration, respectively;

FIGS. 12 and 13 are schematic perspective views of a detail of the variant embodiment of the upright of FIGS. 8 and 9.

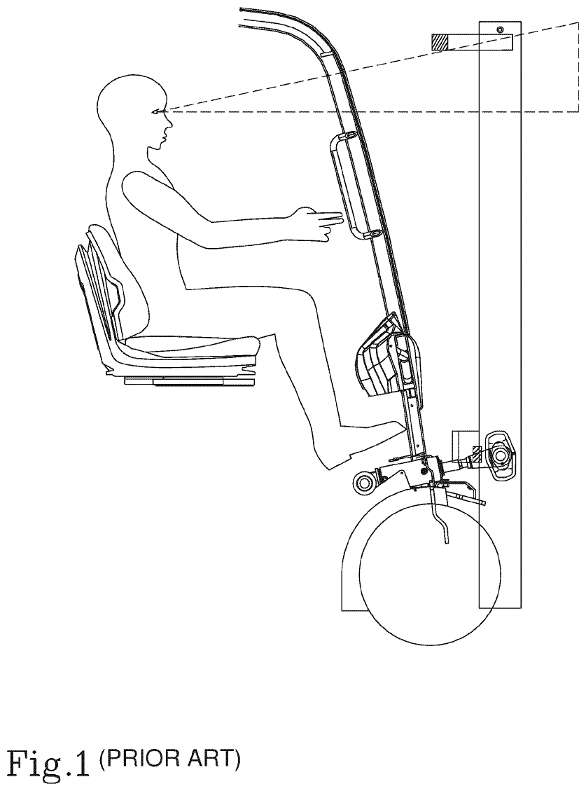

It should be noted that the drawings are schematic and are therefore not representative of the actual dimensions of the system.

### DETAILED DESCRIPTION OF PREFERRED EMBODIMENTS OF THE INVENTION

With reference to the accompanying drawings, the numeral 1 denotes in its entirety an upright of a lift truck having a main extension along a vertical direction Y.

The upright 1 comprises a unit 2 for picking up a load, preferably a pair of forks.

The upright 1 comprises a fixed section 3 and a section 4 movable relative to the fixed section 3, preferably a movable telescopic section 4, for performing the movement of the pickup unit 2 along the vertical direction Y.

The fixed section 3 comprises a first profile 11 and a second profile 12 positioned parallel to each other.

The first profile 11 and the second profile 12 have a main extension along the vertical direction Y.

According to the invention, the first profile 11 and the second profile 12 each have at least a rear wall 13 and an outer side wall 14.

The rear wall 13 of each between the first profile 11 and the second profile 12 is designed to face a driver's cab of a lift truck.

The outer side wall 14 of each between the first profile 11 and the second profile 12 is a free wall facing towards the outside environment.

According to an aspect of the invention, the first profile 11 and the second profile 12 each have a front wall 16.

The front wall 16 of each between the first profile 11 and the second profile 12 faces towards the picking-up unit 2.

According to an aspect of the invention, the first profile 11 and the second profile 12 each have an inner side wall 17.

The inner side wall 17 of each between the first profile 11 and the second profile 12 faces the movable section 4.

According to an aspect of the invention, the movable section 4 comprises at least one pair of profiles movable relative to the first and the second profiles 11, 12, not illustrated in the accompanying drawings, positioned parallel to each other.

It should be noted that this invention applies both to an upright 1 which comprises a single pair of movable profiles, the so-called duplex upright, and to an upright 1 which comprises two pairs of profiles movable relative to each other, the so-called triplex upright.

According to this invention, the fixed section 3 comprises at least one element 5 for connecting the first profile 11 and the second profile 12 positioned close to a free upper end 15 of the upright 1.

The connecting element 5 has a C-shaped profile comprising a main body 50, a first arm 51 and a second arm 52.

The main body 50 is positioned facing the rear walls 13 of first profile 11 and second profile 12.

The first arm 51 and the second arm 52 are parallel to each other and extend from a respective portion of the main body 50 transversally to it.

More specifically, considering the first arm 51, it has a first end portion 51A, connected to the first profile 11, and a second end portion 51B, directly connected to the main body 50, starting from which the first arm 51 extends transversally to the main body 50.

Considering the second arm 52, it has a first end portion 52A, connected to the second profile 12, and a second end portion 52B, directly connected to the main body 50, starting from which the second arm 52 extends transversally to the main body 50.

The main body 50 extends between the second end portion 51B of the first arm 51 and the second end portion 52B of the second arm 52.

The main body 50 is, for example, a bar.

Advantageously, the connecting element 5 makes it possible to make the upright 1 solid at a structural level.

The first arm 51 and the second arm 52 are connected, respectively, to the first profile 11 and to the second profile 12 in respective coupling zones (61, 62).

According to an embodiment, the coupling zone 61 of the first arm 51 is positioned at a portion of the outer side wall 14 of the first profile 11 and the coupling zone 62 of the second arm 52 is positioned at a portion of the outer side wall 14 of the second profile 12.

In other words, the first and the second arms 51, 52 are connected to the upright at the free wall of the first and the second profiles 11, 12 facing towards the outside environment.

In each free wall of the first and second profiles 11, 12 there is a respective plate-shaped body 74 equipped with a through eyelet 75.

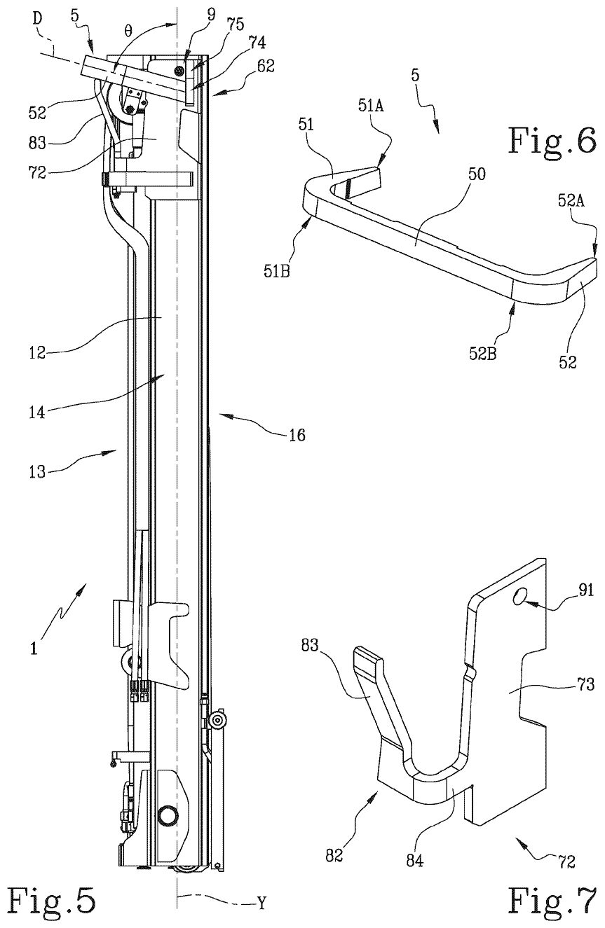

The eyelet 75 has an axis of extension at right angles to the vertical axis Y, as shown in FIG. 5.

The plate-shaped body 74 is positioned close to the coupling of the first and second arms 51, 52 to the first and second profiles 11, 12.

In technical jargon, the plate-shaped body 74 equipped with an eyelet 75 is an eyebolt.

According to this invention, the upright 1 is characterised in that the first arm 51 and the second arm 52 are positioned relative to the first profile 11 and to the second profile 12 in such a way that:
the direction of extension D of the first arm 51 and of the second arm 52 defines an acute angle “θ” with the vertical direction of extension Y of the first profile 11 and of the second profile 12;
the main body 50 is positioned higher than the coupling zones 61, 62 of the first arm 51 to the first profile 11 and of the second arm 52 to the second profile 12.

In other words, the direction of extension D of the first arm 51 and of the second arm 52 is inclined at the acute angle “θ” relative to the vertical direction of extension Y of the first profile 11 and of the second profile 12.

Preferably the acute angle “θ” is between 55° and 85°.

Still more preferably, the acute angle “θ” is equal to 75°.

This inclination determines the positioning of the main body 50 of the connecting element 5 at a height greater than the coupling zones 61, 62 of the first arm 51 to the first profile 11 and of the second arm 52 to the second profile 12.

More specifically, considering the first arm 51, the first end portion 51A is positioned at a lower height than the second end portion 51B. Similarly, the first end portion 52A of the second arm 52 is positioned at a height lower than the second end portion 52B. The connecting element 5, which extends between the second end portion 51B of the first arm 51 and the second end portion 52B of the second arm 52, is therefore positioned at a height greater than the coupling zones 61, 62, respectively, of the first arm 51 to the first profile 11 and of the second arm 52 to the second profile 12.

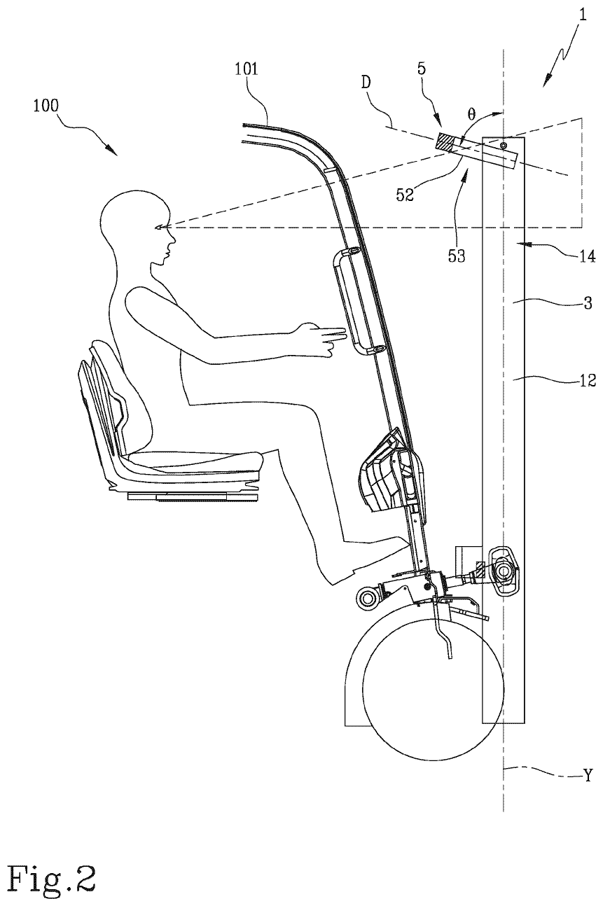

Advantageously, this arrangement of the connecting element 5 makes it possible to improve the field of vision of a driver of the lift truck for which the upright 1 is intended. In effect, in use, as illustrated in FIG. 2, the connecting element 5 of the upright 1 is positioned in such a way as to allow the driver of a lift truck to have a wider visual cone.

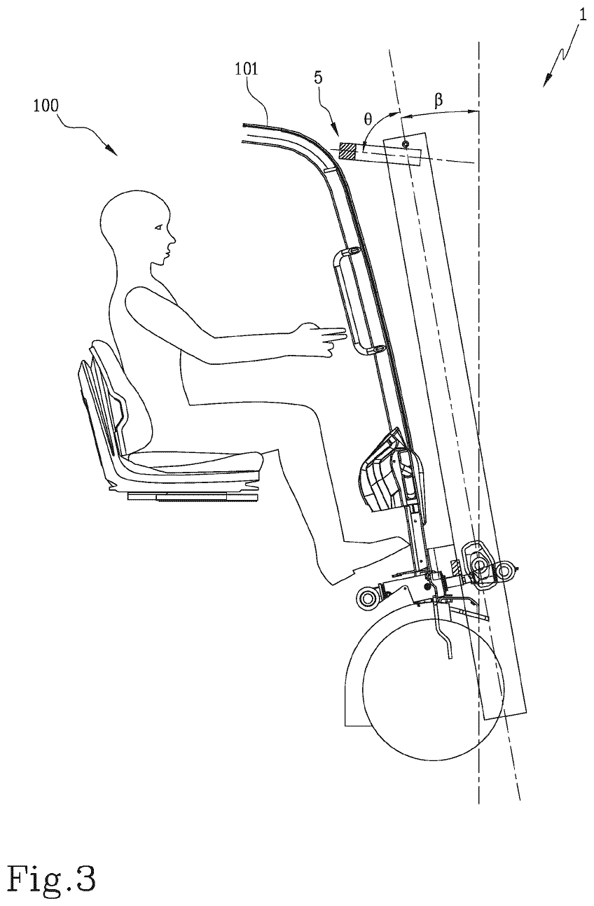

Advantageously, this arrangement of the connecting element 5 allows, in use, the tilting performance of the upright 1 not to be affected. In effect, as illustrated in FIG. 3, the connecting element 5 allows the tilting of the upright 1 towards the driver's cab of the lift truck to which the upright 1 is intended.

It should be noted in FIG. 3 that the connecting element 5, extending as described, amplifies the angle of travel of the tilting of the upright 1 towards the driver's cab: there is a contact between the upright 1 and the driver's cab at a tilting angle greater than that of the prior art solutions.

According to an aspect of the invention, the connecting element 5 defines a window 53 delimited by first arm 51, second arm 52 and main body 50.

The window 53 is inclined by said acute angle “θ” relative to the plane at right angles to the vertical direction Y.

The window 53 allows an operator to see through it.

In other words, the window 53 is part of the field of vision of the operator.

According to an aspect of the invention, the upright 1 comprises at least one element 9 for adjusting the movable section 4 relative to the fixed section 3.

The adjusting element 9 of the movable section 4 is positioned on at least one between the first profile 11 and the second profile 12.

In particular, the adjusting element 9 allows the position of the movable section 4 to be adjusted inside the fixed section 3.

In particular, considering the preferred embodiment wherein the movable section 4 is a telescopic section, the adjusting element 9 allows the movable section 4 to be centred inside the fixed section 3.

According to a preferred embodiment, the coupling zones 61, 62 of the first arm 51 and of the second arm 52 are positioned at a lower height with respect to the adjusting element 9.

In other words, the adjusting element 9 of the movable section 4 is positioned above the coupling zones 61, 62.

Advantageously, this arrangement allows the adjustment element 9 to be accessible.

According to a preferred embodiment, the upright 1 comprises a first supporting element 71 and a second supporting element 72 of the connecting element 5.

The first and the second supporting elements 71, 72 are directly connected, respectively, to the first profile 11 and to the second profile 12 at a portion of the outer side wall 14.

The first arm 51 and the second arm 52 are connected to the first profile 11 by means of the first supporting element 71 and to the second profile 12 by means of the second supporting element 72.

More specifically, according to this preferred embodiment, the connection between the first and the second arms 51, 52 and, respectively, the first profile 11 in the coupling zone 61 and the second profile 12 in the coupling zone 62 is defined as follows: the first and second supporting elements 71, 72 are directly connected, respectively, to the first and second profiles 11, 12 and the first and second arms 51, 52 are directly connected, respectively, to the first and second supporting elements 71, 72.

For example, the first supporting element 71 is welded at a portion of the outer side wall 14 of the first profile 11 and the first arm 51 of the connecting element 5 is welded to the first supporting element 71 and, similarly, the second supporting element 72 is welded at a portion of the outer side wall 14 of the second profile 12 and the second arm 52 of the connecting element 5 is welded to the second supporting element 72.

Each plate-shaped body 74 with eyelet 75, or eyebolt, is welded to the respective first supporting element 71 and to the second supporting element 72.

According to a preferred embodiment, the first supporting element 71 comprises a first bracket 81 and the second supporting element 72 comprises a second bracket 82.

The first bracket 81 and the second bracket 82 are configured to support the connecting element 5.

The first supporting element 71 and the second supporting element 72 support the connecting element 5.

Preferably, the first bracket 81 and the second bracket 82 are positioned facing the rear wall 13 respectively of the first profile 11 and of the second profile 12.

In other words, the brackets (81, 82) are intended to face a driver's cab of a lift truck.

According to this preferred embodiment, the supporting elements 71, 72 may each comprise a main portion 73, preferably a plate, directly connected to the respective profile 11, 12 and the first and the second brackets 81, 82 each have a supporting portion 83 and a connecting portion 84 for connecting the supporting portion 83 to the main portion 73.

Preferably, the supporting portion 83 has a main extension along a direction inclined relative to the respective profiles 11, 12 in such a way that the portion of the brackets 81, 82 positioned at a lower height is at a shorter distance from the rear wall 13 of the respective profile 11, 12.

In particular, the supporting portion 83 of the brackets 81, 82 is preferably positioned facing the rear walls 13 of the first and second profiles 11, 12 in such a way that the projection of the supporting portions 83 on the respective rear walls 13 remains completely inside the surface of the respective rear wall 13.

Preferably, the connecting portion 84 extends in such a way as to have a portion facing the rear wall 13 of the profiles 11, 12 and another portion facing the outer side wall 14 of the profiles 11, 12.

Advantageously, the supporting elements 71, 72 contribute to the structural solidity of the upright 1.

Advantageously, the supporting elements 71, 72 according to the embodiment described allow the window defined between the first profile 11 and the second profile 12 to be kept free, so do not interfere with the field of vision inside the window.

According to an aspect of the invention, the first and the second bracket 81, 82 are directly connected to the main body 50 of the connecting element 5 close to the portion of the main body 50 from which extend, respectively, the first arm 51 and the second arm 52.

In other words, the first bracket 81 and the second bracket 82 are connected to the connecting element 5 at a portion of the main body 50 close, respectively, to the first arm 51 and the second arm 52, in particular the respective second end portions 51B, 52B.

Preferably, the first supporting element 71 and the second supporting element 72 are configured to allow access to the adjustment element 9.

Considering, for example, the embodiment wherein the main portion 73 of each supporting element 71, 72 is a plate, the main portion 73 has a hole 91 and the adjusting element 9 is accessible through the hole 91.

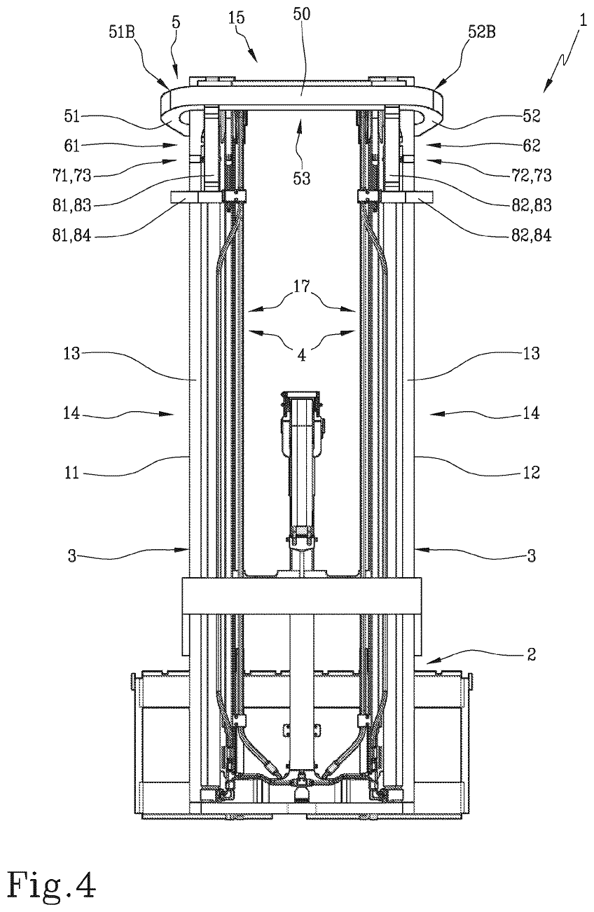

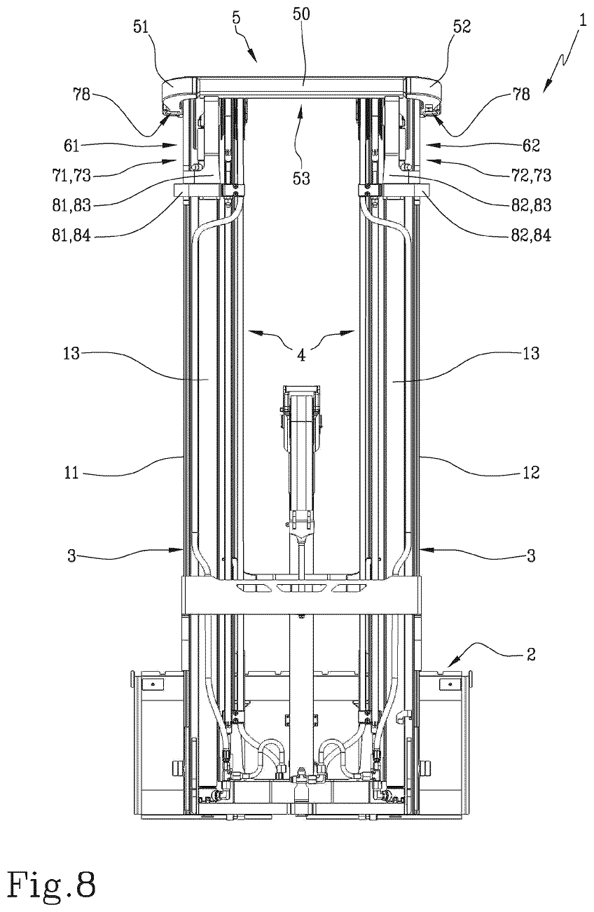

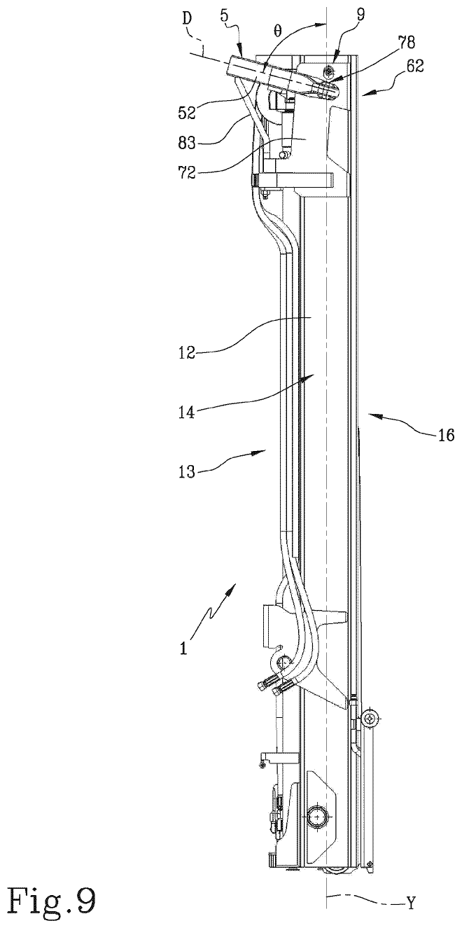

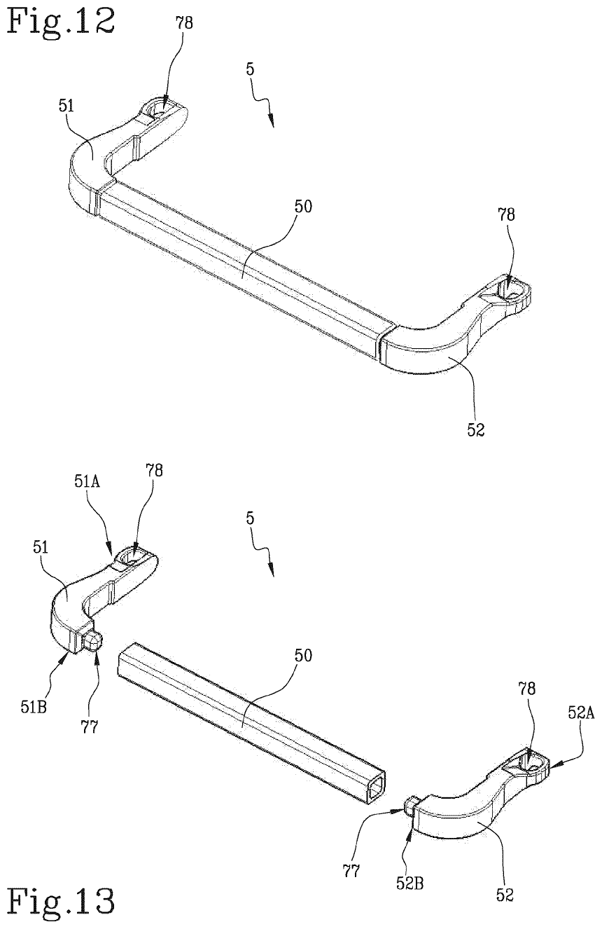

FIGS. 8 to 13 show a variant embodiment of the upright 1 wherein the distinctive element relative to the embodiment of FIGS. 2 to 7 is the shape of the connecting element 5, with the remaining features described remaining unchanged.

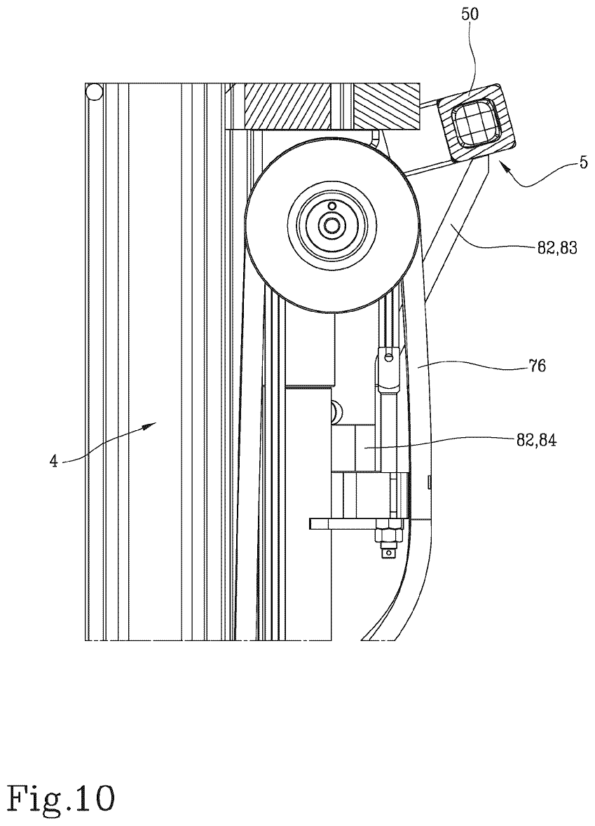

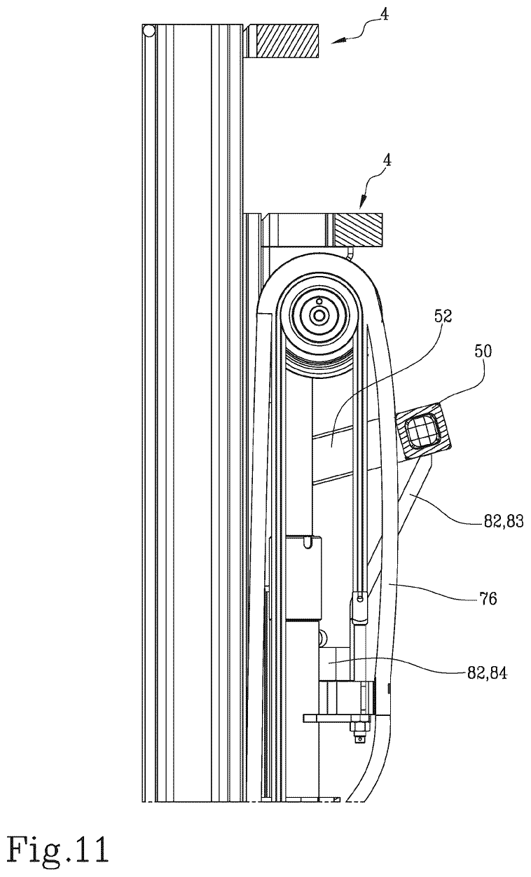

According to this variant embodiment, the connecting element 5 has the main body 50 the surface of which is radiused, as shown clearly in FIGS. 10 and 11.

During the slipping out of the upright 1, shown in FIG. 11, the main body 50 comes into contact with one or more flexible conduits 76 of a pressurised hydraulic circuit and the radiused surface of this variant prevents wear on the conduits due to sliding.

The main body 50 according to this variant embodiment has a hollow cross-section.

Advantageously, the hollow cross-section allows the weight of the main body 50 to be reduced.

More specifically, the cross-section is quadrangular in shape, radiused at each edge.

With reference to the first arm 51 and the second arm 52 they are connected to a respective end of the main body 50.

According to this variant embodiment, the first arm 51 and the second arm 52 comprise at the respective second end portions 51B, 52B a respective male element 77 which can be inserted in the hollow end of the main body 50.

Advantageously, the first arm 51 and the second arm 52 are two identical mechanical components, one of which can be coupled at one end of the main body 50 and the other at the other end of it.

Advantageously, it is possible to vary the length of the main body 50 keeping the shape of the first arm 51 and of the second arm 52 unchanged.

According to this variant, in the proximity of the respective first end portion 51A, 52A, the first arm 51 and the second arm 52 have a through hole 78.

The hole 78 has an axis of extension perpendicular to the direction of extension D of the respective first arm 51 and second arm 52.

Advantageously, according to this variant embodiment, each hole 78 of the first arm 51 and of the second arm 52 defines an eyebolt of the upright 1, preventing the presence of the plate-shaped body 74 with the eyelet 75 of the embodiment shown in FIGS. 2 to 7. This invention also relates to a lift truck 100 comprising a driver's cab 101 and an upright 1 having one or more of the technical features illustrated in this invention.

The rear walls 13 of the first profile 11 and the second profile 12 of the upright 1 face the driver's cab 101 in such a way that the connecting element 5 is oriented on the side of driver's cab 101.

Preferably, the tilting of the upright 1 has a travel of an angle “β” of up to 14°.

1. An upright of a lift truck having a main extension along a vertical direction and comprising a unit for picking up a load;
the upright comprises a fixed section and at least one movable section relative to the fixed section;
the fixed section comprises a first profile and a second profile, having a main extension along the vertical direction positioned parallel to each other;
the first profile and the second profile each have at least a rear wall and an outer side wall,
the rear wall of each between the first profile and the second profile is designed to face a driver's cab of a lift truck;
the outer side wall of each between the first profile and the second profile is a free wall facing towards the outside environment;
the fixed section comprises at least one element for connecting the first profile and the second profile positioned close to a free upper end of the upright,
the connecting element has a C-shaped profile comprising a main body, positioned facing the rear walls of the first profile and second profile, and
a first arm and a second arm, parallel to each other, which extend from a respective portion of the main body transversally to it,
the first arm and the second arm are connected, respectively, to the first profile and to the second profile in respective coupling zones;
the upright is characterised in that the first arm and the second arm are positioned relative to the first profile and to the second profile in such a way that the direction of extension of the first arm and of the second arm defines an acute angle “θ” with the vertical direction of extension of the first profile and of the second profile and in that the main body is positioned at a height higher than the coupling zones (61, 62) of the first arm to the first profile and of the second arm to the second profile.

2. The upright according to claim 1, wherein the connecting element defines a window delimited by the first arm, the second arm and the main body, said window being inclined by said acute angle “θ” relative to a vertical direction.

3. The upright according to claim 1, wherein the acute angle “θ” is between 55° and 85°, preferably 75°.

4. The upright according to claim 1, wherein the coupling zones respectively of the first arm and of the second arm are positioned at a portion of the outer side wall of the first profile and of the second profile, respectively.

5. The upright according to claim 1, comprising a first supporting element and a second supporting element directly connected, respectively, to the first profile and to the second profile at a portion of the outer side wall, the first arm and the second arm being connected to the first profile and to the second profile by means, respectively, of the first supporting element and the second supporting element.

6. The upright according to claim 5, wherein the first supporting element comprises a first bracket and the second supporting element comprises a second bracket, the first bracket and the second bracket being configured to support the connecting element.

7. The upright according to claim 5, wherein the first bracket and the second bracket are positioned facing the rear wall respectively of the first profile and of the second profile.

8. The upright according to claim 5, wherein the first bracket and the second bracket are directly connected to the main body of the connecting element close to the portion of the main body from which extend, respectively, the first arm and the second arm.

9. The upright according to claim 1, comprising at least one element for adjusting the movable section, relative to the fixed section, positioned on one between the first profile and the second profile, the coupling zones of the first arm and of the second arm are positioned at a lower height relative to the adjustment element of the movable section.

10. The upright according to claim 9, wherein the first supporting element and the second supporting element are configured to allow access to the adjustment element.

11. The upright according to claim 1, wherein the main body of the connecting element has a radiused surface.

12. The upright according claim 1, wherein the main body has a hollow cross-section.

13. The upright according to claim 12, wherein the first arm and the second arm comprise at the respective second end portion a respective male element which can be inserted in a respective hollow end of the main body.

14. The upright according to claim 13, wherein close to the respective first end portion, the first arm and the second arm have a respective through hole having an axis of extension parallel to the vertical direction.

15. The upright according to claim 13, wherein the first arm and the second arm are identical mechanical components.

16. A lift truck comprising a driver's cab and an upright according to claim 1, wherein the rear walls of the first profile and the second profile of the upright face the driver's cab in such a way that the connecting element is oriented on the side of driver's cab.

17. The lift truck according to claim 16, wherein the tilting of the upright has a travel of an angle “β” of up to 14°.
